(19) United States
(12) Patent Application Publication
(10) Pub. No.: US 2025/0332674 A1
(43) Pub. Date: Oct. 30, 2025

(54) MACHINE TOOL

(71) Applicant: FANUC CORPORATION, Minamitsuru-gun, Yamanashi (JP)

(72) Inventor: Taisei FUJIMOTO, Yamanashi (JP)

(21) Appl. No.: 18/866,680

(22) PCT Filed: Sep. 27, 2022
(86) PCT No.: PCT/JP2022/035910

§ 371 Date: Nov. 18, 2024

(51) Int. Cl. B23Q 3/155; G05B 19/409

(52) U.S. Cl. CPC B23Q 3/15546; G05B 19/409

(57) ABSTRACT

A machine tool according to an aspect of the present disclosure is capable of appropriately performing a setup task and comprises: a processing device that processes a workpiece by using a tool; one or a plurality of tag readers that are each attached to an article, which is removable and includes the tool, and read a tag that records unique ID information; and a control device which has a setup display unit that displays task information of the setup task to be performed by a worker in accordance with the ID information read by the tag reader.

### TECHNICAL FIELD

The present invention relates to a machine tool.

### BACKGROUND ART

For example, it has been proposed to use tags such as an RFID for management of various manufacturing processes. For example, Patent Document 1 discloses a production management system that identifies the content of the work to be performed by an automated machine based on information read from an ID plate (tag) attached to an automated transport carriage or pallet that transports the objects to be processed.

### CITATION LIST

### Patent Document

Patent Document 1: Japanese Unexamined Patent Application, Publication No. H4-199304

### DISCLOSURE OF THE INVENTION

### Problems to be Solved by the Invention

Even if the content of the required work can be ascertained by identifying the object to be processed with the tag, it must be ensured that the automated machine is in in a state where it can carry out the required work. Specifically, unless an appropriate tool is mounted on a machine tool that performs work, intended machining cannot be accurately performed. That is, it is required to appropriately perform setup work such as mounting a tool on a machine tool.

### Means for Solving the Problems

A machine tool according to an aspect of the present disclosure includes a machining device configured to machine a workpiece with a tool, one or more tag readers configured to read tags that are attached to removable items including the tool and that record unique ID information, and a control device including a setup display unit configured to display work information on setup work to be performed by a worker according to the ID information read by a tag reader of the one or more tag readers.

### Effects of the Invention

According to the present disclosure, it is possible to appropriately perform setup work for a machine tool.

### BRIEF DESCRIPTION OF THE DRAWINGS

FIG. 1 is a block diagram showing the configuration of a machine tool according to an embodiment of the present disclosure.

### PREFERRED MODE FOR CARRYING OUT THE INVENTION

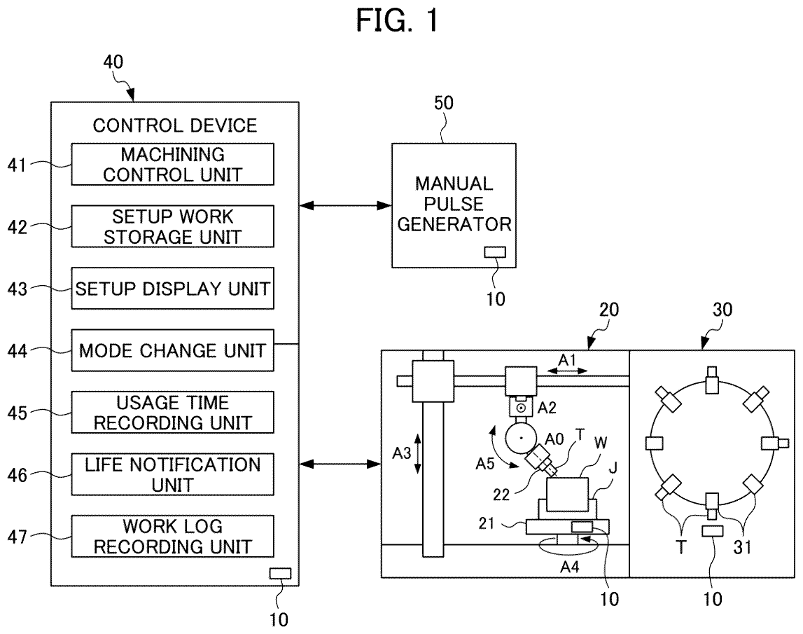

Hereinafter, embodiments of the present disclosure will be described with reference to the drawings. FIG. 1 is a block diagram showing the configuration of a machine tool 1 according to an embodiment of the present disclosure.

The machine tool 1 machines a workpiece W with a tool T. Tags for recording unique ID information may be attached to each of the workpiece W, the tool T, and items required for machining the workpiece W (for example, an adapter for mounting the tool). In addition, a tag for storing ID information unique to a worker is also distributed to the worker who uses the machine tool 1 by being attached to an ID card or the like, for example. As the tag, for example, an IC tag, a bar code, or the like can be used.

The machine tool 1 includes one or more tag readers 10 that read tags, a machining device 20 that machines the workpiece W by relatively moving the workpiece W and the tool T, a tool changer 30 that changes the tool T of the machining device 20, a control device 40 that controls the machining device 20 and the tool changer 30, and a manual pulse generator 50 connected to the control device 40.

The tag reader 10 reads information recorded in the tag. The tag reader 10 used is one that corresponds to the tag, and a non-contact reader is preferably used. The tag readers 10 may be provided in the machining device 20, the tool changer 30, the control device 40, and the manual pulse generator 50. In particular, in the machining device 20 and the tool changer 30, the tag readers 10 are preferably disposed so as to be capable of reading tags in a state where the respective items are disposed in a state where the workpiece W can be machined.

To machine the workpiece W with the tool T, the machining device 20 may include a table 21 that holds the workpiece W directly or via a jig J, a chuck 22 that holds the tool T, and a plurality of drive axes (including a spindle) A0 to A5 that relatively move the table 21 and the chuck 22. The jig J may also be tagged.

The tool changer 30 includes a plurality of tool holders 31 each holding a tool T and selectively positioned with respect to the chuck 22. As shown in FIG. 1, in the tool changer 30, the tag reader 10 is preferably disposed so as to read the tag of the tool T held in the tool holder 31 positioned at a predetermined checking position. As an alternative, although not shown, if the tag reader 10 is provided for each of the plurality of tool holders 31 of the tool changer 30 and reads the tag of the tool T held in the tool holder 31, the correspondence relationship between the tool holder 31 and the held tool T can be accurately checked. As a further alternative, each of the tool holders 31 may be tagged, and the tag of the tool holder 31 and the tag of the held tool T may be subsequently read by a portable tag reader 10.

The control device 40 includes a machining control unit 41, a setup work storage unit 42, a setup display unit 43, a mode change unit 44, a usage time recording unit 45, a life notification unit 46, and a work log recording unit 47, The control unit 40 can be realized by one or more computer devices each including a memory, a processor, an input/output interface, a monitor, etc., and executing appropriate control programs. In the present embodiment, the control device 40 is a so-called numerical control device. The above components of the control device 40 are ones that fall under categorized functions of the control device 40, and do not need to be clearly distinguishable in terms of physical configuration or program configuration.

The machining control unit 41 controls the machining operation on the workpiece W by the machining device 20 according to a machining program written in, for example, a G code or the like. The machining control unit 41 can be configured in the same manner as in a well-known numerical control device.

The setup work storage unit 42 is a database that stores work information on the setup work to be performed by the worker. The work information on the setup work includes information on the items to be used. Specifically, the work information includes the type or ID of the workpiece W to be held on the table 21, the type or ID of the jig J, the type or ID of the tool T to be mounted on the chuck 22 or the tool holder 31 of the tool changer 30, and the like. The setup work storage unit 42 may be configured to be able to update the work information on the setup work to be stored from an external server (not shown).

Since with the machine tool 1, it can be assumed that different workers perform different machining operations, the work information on the setup work may be stored in association with the ID of the worker. In addition, the setup work storage unit 42 may include a separate database that associates the ID of the worker with the setup work, such as a machining schedule for each worker's ID.

The setup display unit 43 displays the work information on the setup work to be performed by the worker according to the ID information read by the tag reader 10. The work information may be displayed on a monitor of the control device 40 or on a monitor of the manual pulse generator 50 or another external device. The setup display unit 43 is configured to obtain the work information on the corresponding setup work from the setup work storage unit 42 or an external server based on the ID information read by the tag reader 10. Since the setup work storage unit 42 or the setup display unit 43 is configured to obtain the work information from an external server, it is possible to easily change the setting of the setup work.

By identifying the tagged item based on the ID information read by the tag reader 10, the setup work required for that item can be identified. As an example, when the ID information of a tool T is identified, the setup display unit 43 displays the number of the tool holder 31 of the tool changer 30 to which the tool T should be attached, the type of the adapter (not shown) required for attachment, and the like as the work information. It is preferable that the adapter is also tagged. This allows the worker to appropriately perform the setup work. When the required setup work includes a plurality of steps, the work information may be sequentially displayed for each step.

When the ID information identifies a worker, the setup display unit 43 is preferably configured to obtain work information associated with the identified worker. For example, it may be required to manufacture different products with the machine tool 1 for each worker at a site of small-volume production of many kinds of products. In such a case, the setup display unit 43 can identify the product to be manufactured by using the ID of the worker as a search key, This allows the content of the required setup work to be accurately identified, so that the production efficiency can be reliably improved. To obtain the ID information of the worker, the control device 40 may be configured to request that the tag reader 10 reads the ID card of the worker.

The mode change unit 44 changes the display mode of the work information when the tag reader 10 reads the ID information of the items related to the work information displayed by the setup display unit 43, thereby indicating that the work is completed.

The usage time recording unit 45 records the usage time of the tool T for each piece of ID information. This allows the lives of the tools T to be managed individually. That is, even when a plurality of tools T of the same type are used in parallel, the degree of wear of each tool T can be relatively accurately ascertained.

When the usage time of the tool T read by the tag reader 10 is equal to or longer than the upper limit, the life notification unit 46 prompts the worker to replace the tool T. This can prevent machining defects due to the use of the tool T beyond the life. In addition, the life notification unit 46 may be configured to prompt the worker to replace the tool T not only when the tag reader 10 reads the tag but also when the usage time of the attached tool T becomes equal to or longer than the upper limit due to the machining performed by the machining control unit 41.

The work log recording unit 47 records the time from the display of the work information by the setup display unit 43 to the reading of the ID information of the items presented in the work information. This allows the work efficiency of the setup work to be checked. Furthermore, if the time until the reading of the ID information of the items is recorded for each worker's ID, it is possible to objectively evaluate the accuracy and the proficiency of the work of each worker.

The manual pulse generator 50 is a well-known jog operation terminal that allows the worker to operate the machining device 20 by a desired driving amount. By providing a tag reader 10 in a portable manual pulse generator 50, tags attached to items such as the tool T can be read relatively easily. Furthermore, by configuring the manual pulse generator 50 to read the tag of the item in a state of being attached to the machining device 20 or the tool changer 30, it is possible to ensure that appropriate items are attached to appropriate positions relatively accurately while omitting the disposition of the tag readers 10 in the machining device 20 and the tool changer 30.

Since the machine tool 1 according to the present disclosure includes the setup display unit 43 that displays the work information on the setup work to be performed by the worker according to the ID information read by the tag reader 10, appropriate setup work, i.e., attaching items such as the appropriate tool T and jig J to the appropriate locations, can be ensured.

The following supplementary notes are further disclosed with respect to the above-described embodiments and modifications.

### (Supplementary Note 1)

A machine tool (1) includes a machining device (20) that machines a workpiece (W) with a tool (T), one or more tag readers (10) that read tags that are attached to removable items (T, W, J) including the tool (T) and that record unique ID information, and a control device (40) including a setup display unit (43) that displays work information on setup work to be performed by a worker according to the ID information read by a tag reader (10).

### (Supplementary Note 2)

When the ID information identifies the worker, the setup display unit (43) may obtain the work information associated with the worker.

### (Supplementary Note 3)

The setup display unit (43) may obtain the work information from an external server.

### (Supplementary Note 4)

The work information displayed by the setup display unit (43) may include information on the items (T, W, J,) to be used. The control device (40) may further include a mode change unit (44) that changes the display mode of the work information when a tag reader (10) read the ID information of the items (I, W, J,) related to the work information.

### (Supplementary Note 5)

The control device (40) may further include a work log recording unit (47) that records a time from the display of the work information by the setup display unit (43) to the reading of the ID information of the items (T, W, J),

### (Supplementary Note 6)

A tag reader (10) may be provided in a manual pulse generator (30).

### (Supplementary Note 7)

The machine tool (1) may further include a tool changer (30) including a plurality of tool holders (31) each holding the tool (T). A tag reader (10) may be disposed so as to read a tag of the tool (T) held in a tool holder (31) positioned at a predetermined checking position.

### (Supplementary Note 8)

The machine tool (1) may further include a tool changer (30) including a plurality of tool holders each holding the tool. The tag readers (10) may be respectively provided in the plurality of tool holders.

### (Supplementary Note 9)

The control device (40) may further include a usage time recording unit that records the usage time of the tool for each piece of the ID information.

Although the present disclosure has been described in detail above, the present disclosure is not limited to the above-described embodiments. Various additions, substitutions, modifications, partial deletions, and the like can be made to the above-described embodiments without departing from the gist of the present disclosure or the spirit of the present disclosure derived from the contents recited in the Claims and the equivalents thereof. In addition, in the above-described embodiments, the order of each operation and the order of each process are shown as examples, and the present disclosure is not limited thereto.

As an example, in the machine tool according to the present disclosure, the tool changer and the manual pulse generator are not essential components. In the machine tool according to the present disclosure, the machining device may have any configuration. Furthermore, in the control device of the machine tool according to the present disclosure, the setup work storage unit, the mode change unit, the usage time recording unit, the life notification unit, and the work log recording unit are not essential components.

### EXPLANATION OF REFERENCE NUMERALS

1 machine tool
10 tag reader
20 machining device
21 table
22 chuck
30 tool changer
31 tool holder
40 control unit
41 machining control unit
42 setup work storage unit
43 setup display unit
44 mode change unit
45 usage time recording unit
46 life notification unit
47 work log recording unit
50 manual pulse generator
A0 to A5 drive axes
J jig
T tool
W workpiece

1. A machine tool comprising:
a machining device configured to machine a workpiece with a tool;
one or more tag readers configured to read tags that are attached to removable items including the tool and that record unique ID information; and
a control device comprising a setup display unit configured to display work information on setup work to be performed by a worker according to the ID information read by a tag reader of the one or more tag readers.

2. The machine tool according to claim 1, wherein, when the ID information identifies the worker, the setup display unit obtains the work information associated with the worker.

3. The machine tool according to claim 1, wherein the setup display unit obtains the work information from an external server.

4. The machine tool according to claim 1,
wherein the work information displayed by the setup display unit comprises information of the items to be used, and
wherein the control device further comprises a mode change unit configured to change a display mode of the work information when a tag reader of the one or more tag readers read the ID information of the items related to the work information.

5. The machine tool according to claim 4, wherein the control device further comprises a work log recording unit configured to record a time from display of the work information by the setup display unit to reading of the ID information of the items.

6. The machine tool according to claim 1, wherein a tag reader of the one or more tag readers is provided in a manual pulse generator.

7. The machine tool according to claim 1,
further comprising a tool changer comprising a plurality of tool holders each configured to hold the tool,
wherein a tag reader of the one or more tag readers is disposed so as to read a tag of the tool held in a tool holder positioned at a predetermined checking position.

8. The machine tool according to claim 1,
further comprising a tool changer comprising a plurality of tool holders each configured to hold the tool,
wherein the tag readers are respectively provided in the plurality of tool holders.

9. The machine tool according to claim 1, wherein the control device further comprises a usage time recording unit configured to record a usage time of the tool for each piece of the ID information.
